(19) United States
(12) Patent Application Publication
(10) Pub. No.: US 2002/0020504 A1
(43) Pub. Date: Feb. 21, 2002

(54) Labeling device

(76) Inventor: Yun-Ming Kwang, Taipei (TW)

Correspondence Address: DOUGHERTY & TROXELL, SUITE 1404, 5205 LEESBURG PIKE, FALLS CHURCH, VA, 22041, US

(21) Appl. No.: 09/838,111

(22) Filed: Apr. 20, 2001

(30) Foreign Application Priority Data
Sep. 19, 2000 (TW) 89119190
May 6, 2000 (TW) 89207556

(51) Int. Cl. B32B 31/00

(52) U.S. Cl. 156/582

(57) ABSTRACT

The invention is related to a mechanical device and method for labeling sticker on business card type of CD, and the device includes a sticker accepting base, a CD accepting base and a resilient unit. The said sticker-accepting base has an accepting plane for placing labeling stickers and the center of the said accepting plane is a central hole. Another side of the accepting plane is with a support foot base for standing up the sticker accepting base. The said CD accepting base is as an “U” type of module and the upper side is with two vertical and parallel side plates along two edges of the base, therefore, the turnabout of sticker accepting plane is limited and the vertical movement of CD can be guided. The top ends of the two side plates of the CD accepting base are ladder type of planes and the said ladder planes are for placing two parallel straight edges of CD. Central part of the CD accepting base is a positioning central pillar. The resilient unit is below the CD accepting base and it is to support the CD accepting base. The CD accepting base can be moved up and down.

### FIELD OF THE INVENTION

The invention is related to a device for sticking label on CD, especially, a business card type CD.

### BACKGROUND OF THE INVENTION

CD is a high storing capacity media and has being used mostly at the digital time. In general, different kinds of information can be imported into a CD for use. Current CDs in the market are normally of 120 mm and 80 mm in diameters. The business card type CD is a new one. Since CD-R, CD-RW have being broadly used, variable contents of CDs can be done by DIY (Do It Yourself). For most of CD-R and CD-RW, their backsides are not printed with required information. So, a CD label may be required and be stuck on the backside of CD for protection and management purposes. Most devices for labeling stickers on CDs are designed for round CD. On the other hand, business card type of CD usually has at least two parallel straight edges, and the label for it is not a round type. Therefore, the labeling device for round CD sticker is not suitable for the business card type of CD sticker.

### SUMMARY OF THE INVENTION

The purpose of the invention is to offer a mechanical device and method for labeling sticker on business card type of CD, and user can easily and precisely stick non-round labeling sticker on the backside of business card CD. Moreover, the device may cooperate with other products to provide the function of sticking sticker on business card type CDs.

The present invention discloses a device for labeling sticker on business card CD, including a sticker accepting base, a CD accepting base and a resilient unit.

The sticker-accepting base has a sticker-accepting plane. The said sticker-accepting plane is a polygon with at least two parallel straight edges. In its center, there is a central hole. The width of the sticker-accepting plane is equal to the distance of the two parallel straight edges, the width of the label and the width of the opening formed by the CD accepting base's two vertical side plates. The length of the sticker-accepting plane is not shorter than the length of the labeling sticker. The other side of the sticker-accepting plane is with two foot bases for standing up the sticker-accepting base.

CD accepting base is a U-shaped module, and there are two side plates vertically stretching out from two ends of the bottom plate. When in use, the U-shaped module's opening is facing up. The width between the inner walls of the two side plates is equal to the width of the sticker accepting plane. The two vertical side plates restrict the sticker accepting base of being turning around. They are also a guiding mechanism for vertically guiding the movement of the CD accepting base. The top ends of these two side plates are ladder planes. The two parallel straight edges of CD are placed on the ladder planes. Because of the limitation by the ladder planes and the two side plates, the CD cannot rotate free. The width of the sticker is smaller than CD's width.

Along with the central axis of the labeling device, there is a position central pillar, which is a positioning mechanism for ensuring the concentricity of all engaging elements. The diameter of the central pillar is equal to the diameters of the central hole of the accepting plane of the sticker accepting base, the central hole of the CD and the central hole of the labeling sticker. When in operating, the central pillar goes through the central holes of the sticker accepting plane, sticker, CD, etc.

Resilient unit is under the CD accepting base for supporting the CD accepting base. Before starting the operation, the ladder planes of the two top ends of the CD accepting base are away from the sticker accepting plane with suitable distance.

### BRIEF DESCRIPTION OF THE DRAWINGS

FIG. 1 is the exploded drawing of the basic structure and the first embodiment of the invention.

FIG. 2 is the assembled 3-D drawing of the first embodiment of FIG. 1.

FIG. 3 is the exploded drawing of the second embodiment of the invention, wherein, the sticker accepting base is changed to “U” type of module.

FIG. 4 is the 3-D drawing of the third embodiment of the invention, wherein, the sticker accepting base is changed to “Π” type of module.

FIG. 5 is the exploded drawing of the fourth embodiment of the invention, wherein, both of the sticker accepting base and CD accepting base are “Π” type of modules, thus, the two “Π” type of modules are assembled and help each other in function. Each of them is with the functions of sticker accepting base and CD accepting base. When one of them is as a sticker accepting base, the other one is a CD accepting base, and vise versa.

FIG. 6 is the 3-D drawing of the fourth embodiment of FIG. 5.

FIG. 7 is the exploded drawing of the fifth embodiment of the invention, wherein, both of the sticker accepting base and CD accepting base are “Π” type of modules. The two modules are assembled one assembly and the assembly cooperates with a moving mechanism of another CD labeling machine to offer the function of labeling sticker on business card type of CD. The two modules of the sticker accepting base and CD accepting base help each other and each of them is with the functions of sticker accepting base and CD accepting base. When one of them is as a sticker accepting base, the other one is a CD accepting base, and vise versa.

FIG. 7A is the 3-D drawing of the fifth embodiment of FIG. 7.

FIG. 8 is the exploded drawing of the sixth embodiment of he invention, wherein, there is an extended central positioning rodin the moving mechanism. The said central positioning rod has two different diameters. Wherein, both of the sticker accepting base and CD accepting base are “Π” type of modules, thus, the two modules are assembled one assembly and the assembly cooperates with a moving mechanism of another CD labeling machine to offer the function of labeling sticker on business card type of CD. The two modules of the sticker accepting base and CD accepting base are the assembly of helping each other and each of them is with the functions of sticker accepting base and CD accepting base. When one of them is as a sticker accepting base, the other one is a CD accepting base, and vise versa.

FIGS. 9 and 10 are the cross-section views of operating process of the fifth embodiment from FIG. 7.

FIG. 11 is the exploded drawing of the seventh embodiment of the invention, wherein, the sticker accepting base, CD accepting base and resilient unit are assembled in one assembly, which cooperates with mechanisms of other products to offer the function of labeling sticker on business card type of CD. The shapes of the sticker accepting base and the CD accepting base of the assembly are the same, and the two modules help each other and each of them is with the functions of sticker accepting base and CD accepting base. When one of them is as a sticker accepting base, the other one is a CD accepting base, and vise versa.

FIG. 12 is the cross-section view of the seventh embodiment of FIG. 11.

FIG. 13 is the drawing of the eighth embodiment of the invention, wherein, the two top ladder planes of the side plates of the CD accepting base are replaced by ribs of the internal side plates.

FIG. 14 is the drawing of the ninth embodiment of the invention, wherein, the sticker accepting base, CD accepting base and central pillar are assembled a lone mechanism. Both of the sticker accepting base and CD accepting base are “Π” type of modules, and they are assembled an assembly, also, the two modules help each other in function. Each of them is with the functions of sticker accepting base and CD accepting base. When one of them is as a sticker accepting base, the other one is a CD accepting base, and vise versa. Both of the two internal side plate of each “Π” type of module have at least one guiding slot. Each of the vertical sides of the two parallel straight edges of the accepting plane has at least one convex point, which cooperates with the guiding slot for guidance and buffer.

FIG. 15 is the drawing of the tenth embodiment of the invention. The embodiment is the extension of the basic structure of FIG. 1, wherein, CD accepting base is fixed on the central pillar. When operating, the sticker accepting base and sticker are raised up directly and let glued surface of sticker touch sticking surface of CD to finish the work of labeling sticker. There is a locking upper disc beyond CD, and the said locking upper disc is placed on CD with hand pressing when operating. After sticker base rose up to touch CD, the locking upper disc prevents the condition of moving of CD.

FIG. 16 is the basic structure exploded drawing of the eleventh embodiment of labeling device of the invention.

FIG. 17 is the cross-section view of the eleventh embodiment of FIG. 16.

FIG. 18 is the cross-section view of the twelfth embodiment of the invention, wherein, the positioning central pillar is structured by two different diameters of cylinders.

FIG. 19 is the cross-section view of the thirteenth embodiment of the invention, the positioning central pillar is structured by two different diameters of cylinders, and CD is supported by top plane of larger cylinder. The two parallel straight edges of CD are limited by the two vertical side plates and not moving around free.

FIG. 20 is the exploded drawing of the fourteenth embodiment of the invention, wherein, CD accepting base is a “Π” type of module.

FIG. 21 is the exploded drawing of the fifteenth embodiment of the invention, wherein, the sticker accepting base and CD accepting base both are “Π” type of module. The width formed by the two vertical side plates of the sticker accepting base is equal to the width of the second accepting plane of the CD accepting base. The width of the sticker accepting plane and the distance between the two vertical side plates of the CD accepting base are same. The positioning central pillar can be taken apart. The CD accepting base and sticker accepting base can be exchanged for usage for being suitable to different widths of CD.

FIG. 22 is the exploded drawing of the sixteenth embodiment of the invention, wherein, the position central pillar is structured by two different diameters of cylinders and fixed on the CD accepting base. Other sections of the drawing are same with the embodiment of FIG. 21.

FIG. 23 is the exploded drawing of the seventeenth embodiment of the invention, wherein, the resilient support module is a commonly sold CD labeling machine in market, and it is with a positioning base of moving up and down.

FIG. 24 is the 3-D drawing of the eighteenth embodiment of the invention, wherein, the top ladder planes of the two side plates of CD accepting base are vertical ribs instead.

FIG. 25 is the exploded drawing of the nineteenth embodiment of the invention, wherein, the sticker accepting base and the CD accepting base both are “Π” type of modules. Each of the “Π” type of modules of which every of the two internal side plates has at least one groove. The two parallel straight edges of bottom planes, each side is with at least one convex point which cooperates with the guiding slot for guidance and buffer.

### DETAILED DESCRIPTION OF THE PREFERRED EMBODIMENT

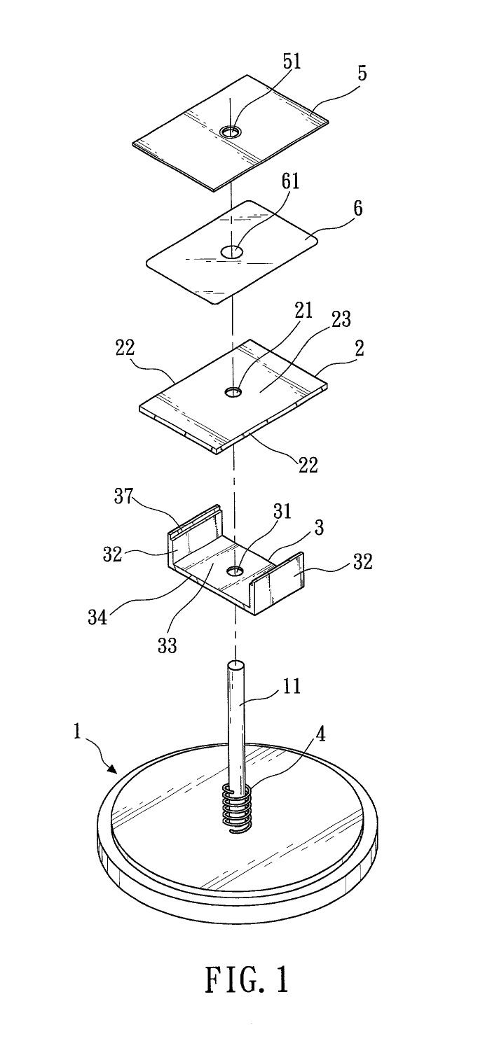

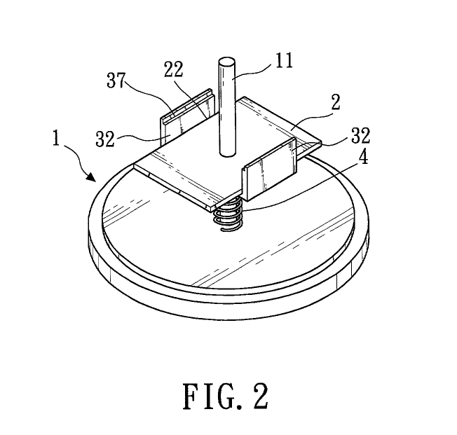

Referring to FIGS. 1 and 2, the first embodiment of the device of labeling sticker on business card type of CD (hereafter referring as CD) includes a base 1, a sticker accepting base 2 (or also called as first accepting base), a “Π” type of CD accepting base 3 (or also called as second accepting base) and a resilient support module 4. There is a central pillar 11 on the base 1 and the function of the central pillar 11 offers the central positioning (means central positioning mechanism of the co-axis of the sticker accepting base 2 (first accepting base), CD accepting base 3 (second accepting base), CD 5 (second plane module), and labeling sticker 6 (first plane module) etc.. The central pillar 11 serves as the guidance of moving up and down of CD accepting base 3. The central pillar 11 can be integrally formed with the base bottom plate 12 to be one module, or it also can be a separately manufactured, and then be assembled with the bottom plate to form the base 1.

Sticker accepting base 2 is a polygon plate module with at least two parallel straight edges 22 and fixedly mounted somewhere on the central pillar 11. Accepting plane 23 (also called as first accepting plane) of the sticker accepting base is placed in between open place 33 of the two side plates of the CD accepting base and the width (means the distance between the two parallel straight edges) is equal to or smaller than the open place 33 of the two side plates. The accepting plane 23 is long enough to load labeling sticker 6. The function for sticker accepting base 2 is to support labeling sticker 6 at a predetermined position, thus, the CD 5 which is located on the top ends of the side plates 32 will be kept away from the labeling sticker 6 when no external force is applied, and the guidance (means moving and positioning mechanism) is made for moving up and down of CD accepting base 3. There is a suitable distance between the accepting plane 23 of the sticker accepting base and CD 5 beyond the accepting plane 23 before operating.

The combination of the sticker accepting base 2 and central pillar 11 can be either an integrally formed structure or separate modules united as a whole.

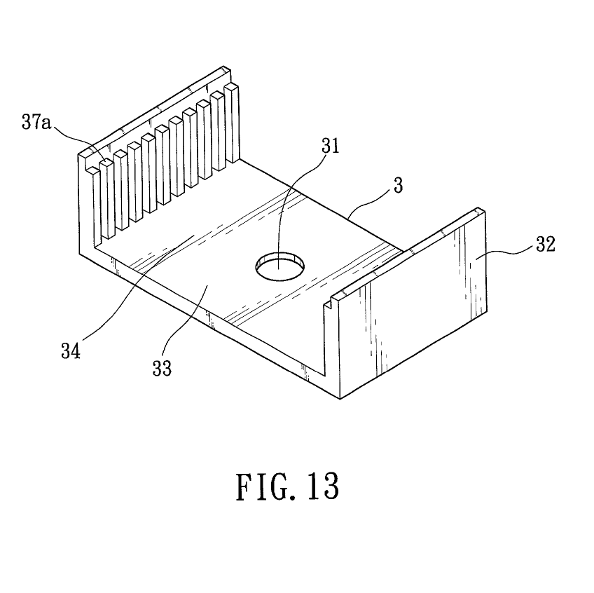

CD accepting base 3 is a “U” shaped module having two side plates 32 (also called as second side plate) vertically standing up. The two side plates 32 are connected by a bottom plane 34 which is located at the bottom side of the open place 33. The two side plates 32 are for supporting business card type of CD 5 at top ends thereof and for preventing the sticker accepting base 2 and labeling sticker 6 from rotating about the central pillar 11. Therefore, relative angular positions between the CD 5 and sticker 6 can be well retained and aligned. There are two ladder planes 37 (also referred as support plane) formed on top of the two side plates 32, and the two parallel sides of CD 5 are placed on the two ladder planes 37. Although in this embodiment, there is only one step formed by the ladder planes 37, as shown in FIG. 1. However, in another preferred embodiment which is not shown in the figures, the ladder planes can also be formed with several steps so as to be suitable with different widths of business card CDs. The two ladder planes 37 can also be replaced by other mechanism, for example, referring to FIG. 13, a plurality of vertical ribs 37a formed on the internal surfaces of the two side plates 32 for supporting the two parallel sides of CD on top ends of the ribs 37a.

Resilient support module 4 is to support CD accepting base 3 and offer buffer function in labeling sticker process. Before labeling, which means the resilient support module 4 is under uncompressed, CD accepting base 3 is at the first position relative to sticker accepting base 2. Meantime, the resilient support module 4 raises the CD accepting base 3, and therefore there are suitable distances between the two ladder planes 37 of the top CD accepting base 3 and sticker accepting base 2 on which the sticker 6 is resting. When beginning operating, A user can hold the two side plates 32 by fingers and then push the CD accepting base 3 downward. As a result, the resilient support module 4 is compressed, and CD accepting base 3 and CD 5 moves down toward labeling sticker 6 on sticker accepting base 2. That is when CD accepting base 3 moves to the second position relative to sticker accepting base 2, and sticker 6 then sticks on CD 5 precisely.

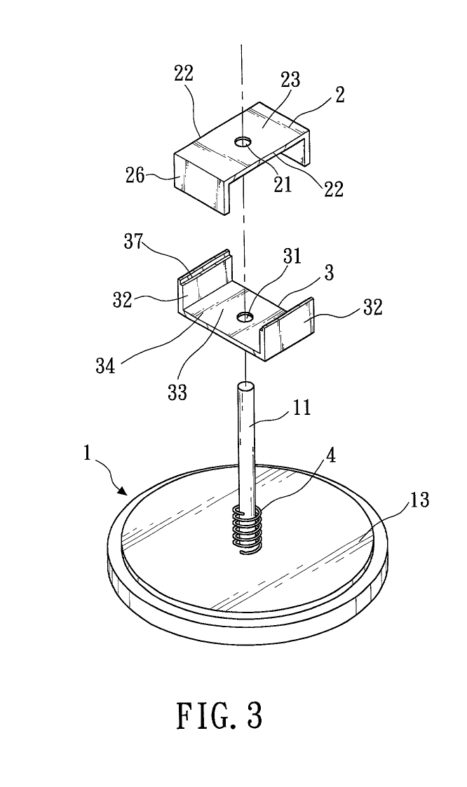

As shown in FIG. 3, which is a second embodiment. For this case, sticker accepting base 2 is a “U” type of module. The “U” type of sticker accepting base 2 and central pillar 11 can be an integrally formed one-body structure, or separate modules combined together. The two side plates 26 (also called as first side plate) of the “U” type of sticker accepting base (first accepting base) are the support foot base, and so sticker accepting base 2 stands on bottom plate plane of base 13. “U” type of sticker accepting base 2 has an accepting plane 23, which length is not shorter than the length of sticker label. The width of the accepting plane 23 is equal to the width of open place 33 of the two side plates of CD accepting base. The height of the two side plates 26 (means the height of the support foot base) shall be that keeping a suitable distance between the accepting plane 23 with the bottom plate plane of base 13 below the accepting plane 23 and the accepting plane 23 with CD 5 (not shown in figure) above the accepting plane. The above mention is as the embodiment of FIG. 1.

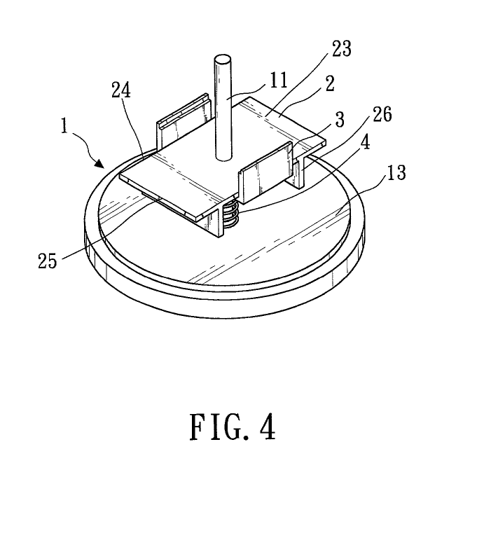

As showing in FIG. 4, which is the third embodiment of the invention. In this case, sticker accepting base 2 is a “Π” type of module. The difference. between “U” type sticker accepting base (as which shown in FIGS. 1˜3) and “Π” type sticker accepting base (shown in FIG. 4) is that the “Π” type sticker accepting base 2 further has two side fins 25 horizontally extending from two sides of the accepting plane 23. The side fins 25 can let users more easy to grib, push or pull the sticker accepting base 2. The “Π” type of the sticker accepting base 2 and central pillar 11 can be a one-body structure, or separate modules combined together.

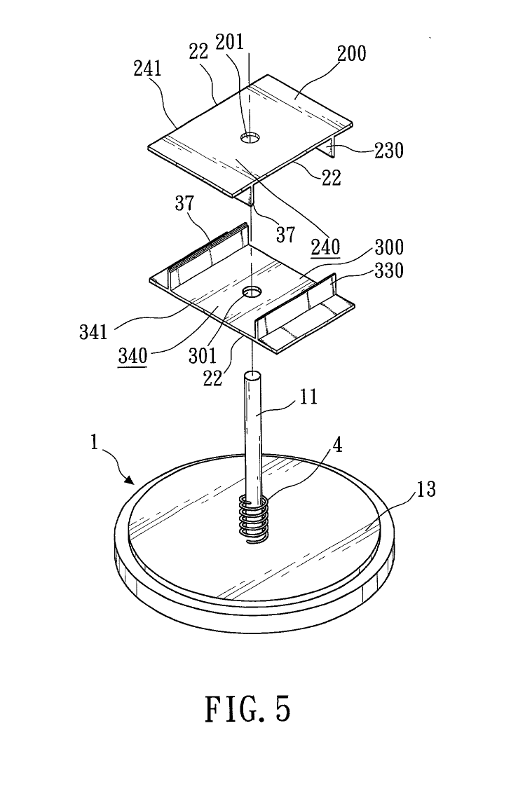

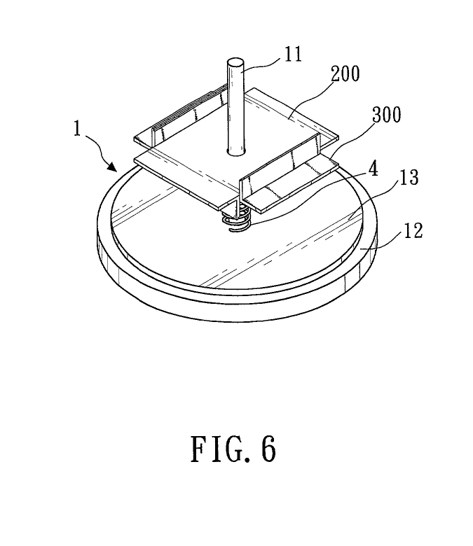

FIGS. 5 and 6 illustrate the fourth embodiment of the invention. In this case, sticker accepting plane and CD accepting plane are both “Π” type of modules for facilitating user operation, which are the first “Π” type of accepting base 200 and the second “Π” type of accepting base 300. Both of the “Π” type of accepting bases are formed with accepting plane and side plates. The first “Π” type of accepting base has a first accepting plane 240, two first “Π” type of side plates 230 and a first bottom plane 241. The second “Π” type of accepting base has a second accepting plane 340, second “Π” type of side plates 330 and second bottom plane 341.

Wherein, the distance between the two first “Π” type of side plates 230 is equal to the width of the second accepting plane 340 of the second “Π” type of accepting base. The width of the first accepting plane 240 of the first “Π” type of accepting base is equal to the distance between the two second “Π” type of side plates 330 of the second “Π” type of accepting base. The heights of the side plates of both “Π” type of accepting bases are all equal, however, the distance between side plates 230 are not necessary to be equal to the distance between side plates 330.

For the embodiment, the first “Π” type of accepting base 200 is responsible for the function of sticker accepting base as which previously described. The second “Π” type of accepting base 300 is responsible for the function of CD accepting base. In case of exchanging the roles of the two accepting bases, which means the first “Π” type of accepting base 200 is responsible for the function of CD accepting base and the second “Π” type of accepting base 300 is responsible for the function of CD accepting base, it can be used for different widths of CDs. If there are a plurality of “Π” type of accepting bases with cooperating function, and the above conditions are matched, those accepting bases can be exchanged each other for usage, and the width range of CD can be more.

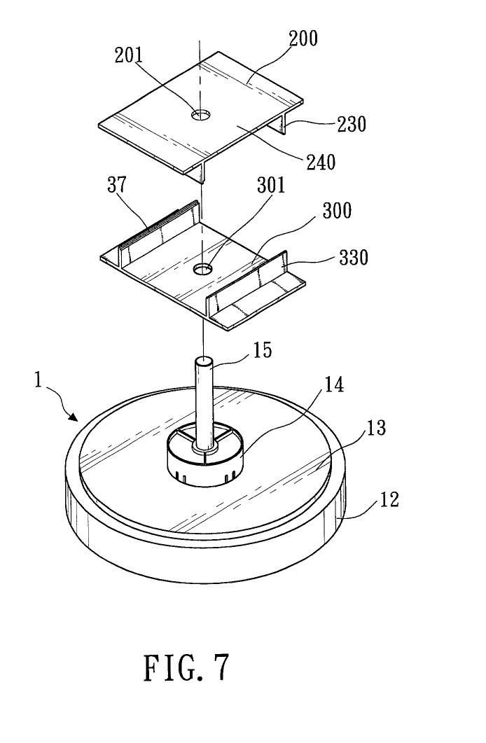

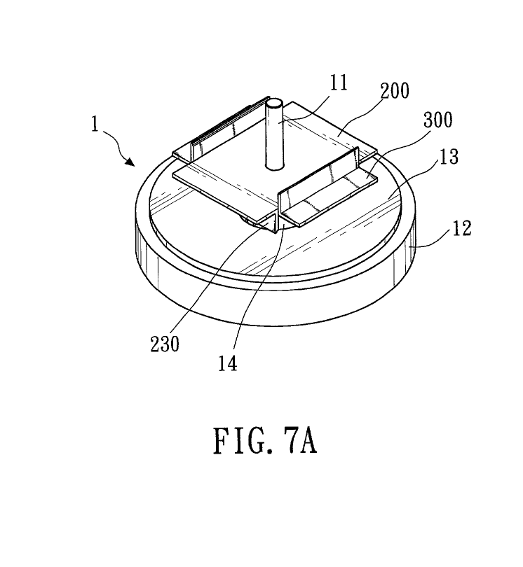

As showing in FIGS. 7, 7A, 9 and 10, which illustrate the fifth embodiment of the invention. In this case, the first “Π” type of accepting base 200 and second “Π” type of accepting base 300 are applied to the device with a CD labeling machine. Wherein, the modules of base, central pillar, resilient support module, etc. are similar parts on such devices. Referring to figures, which is a prior art of 5.25-inches round CD labeling machine. It includes a base bottom plate 12 and a positioning base 14 capable of moving up and down. An additional extended central positioning rod 15 is mounted on the moving and positioning base 14. The central positioning rod 15 and the moving and positioning base 14 are concentric. The height of the side plates of the two “Π” type of modules is cooperated with the travel length of the moving and positioning base 14 for making sure that business card CD may touch the sticker within the travel length. The roles and functions of the first “Π” type of accepting base 200 and second “Π” type of accepting base 300 can be exchanged with each other, which is the same as shown in FIG. 5 of the embodiment.

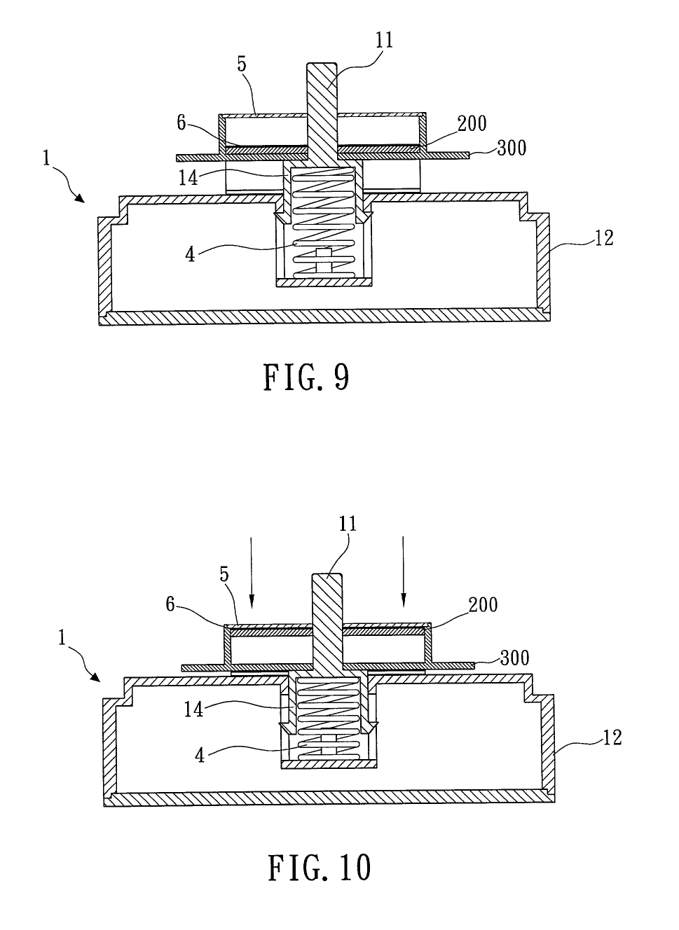

When using, the open place of the second “Π” type of accepting base 300 is toward up, and placing the accepting base on top surface of the moving and positioning base 14 on labeling machine. On the other hand, the open place of the first “Π” type of accepting base 200 is toward down and placing the accepting base on the second “Π” type of accepting base 300. The central positioning rod 15 penetrates the central holes 201 and 301 of the two accepting bases. The first “Π” type of side plates 230 for the first “Π” type of accepting base 200 is supported by the base bottom plane 13. Before operating, ladder plane 37 of two top side plates of the second “Π” type of accepting base is higher than first accepting plane 240 of the first “Π” type of accepting base (means the second “Π” type of accepting base 300 is placed on the first position as shown in FIG. 9).

When operating, firstly, let the glued surface of labeling sticker 6 face up and make its central hole 61 passing through the central positioning rod 15. Then, rest the labeling sticker 6 on the first accepting plane 240 of the first “Π” type of accepting base. Secondly, sticking surface of business card type of CD 5 is toward down. The central hole 51 penetrates the central positioning rod 15. Then, place the CD 5 on the ladder plane 37 of the second “Π” type of side plates 330. Thereafter, pushing the central positioning rod 15 down and the base 14, the second “Π” type of accepting base 300 and CD 5 are moving down together. Labeling sticker is then precisely sticking on CD (meantime, the second “Π” type of accepting base 300 is placed on the second position as shown in FIG. 10), when the sticking surface of CD 5 touches to labeling sticker 6 (not shown in figure) on the first accepting plane 240.

In the embodiment, the first “Π” type of accepting base 200 as sticker accepting base can be changed to the “U” type of sticker accepting base 2 as illustrated in FIG. 3 of the embodiment, or the “□Π” type of sticker accepting base 2 in FIG. 4 of the embodiment or the flat-sheet type base 2 shown in FIG. 1. The sticker accepting base of such structure will not beyond the range of the invention.

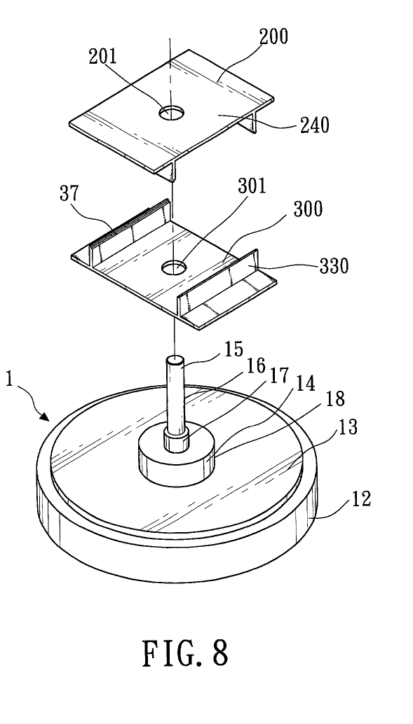

FIG. 8 is the sixth embodiment of the invention. This case is the extended embodiment of FIG. 7 and suitable for that the central hole of labeling sticker is larger than the central hole of CD. Wherein, an extended central positioning rod 15 of the moving and positioning base 14 has two sections of different diameters, which are first diameter 16 of upper section and second diameter 17 of lower section. The length of lower section is equal or smaller than the travel length of the moving and positioning base 14 completing a circle of operation. It is also same as the distance between the ladder plane 37 of the top two side plates of the second “Π” type of accepting base 300 and the first accepting plane 240 of the first “Π” type of accepting base 200 before operating. The diameter of the first diameter 16 is equal to the diameter of central hole 51 of CD. The diameter of the second diameter 17 and central hole 61 of labeling sticker are identical. The second diameter 17 is greater than the first diameter 16. Both the diameters of first central hole 201 and second central hole 301 are same as the second diameter 17.

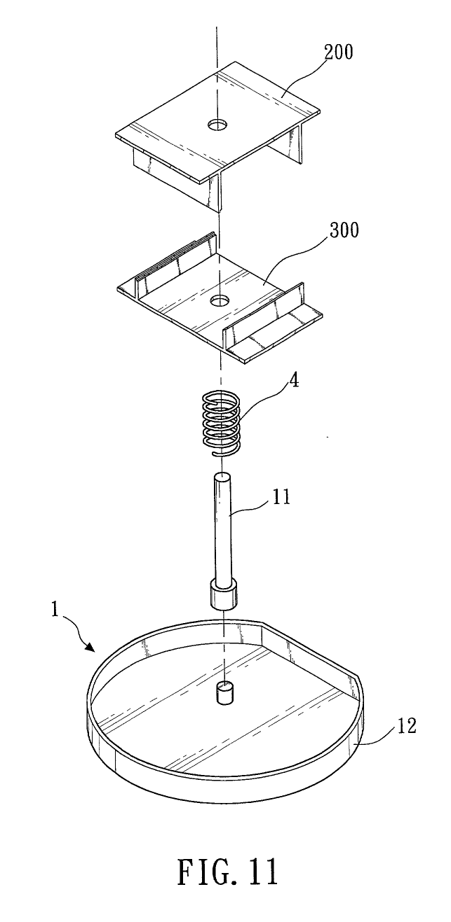

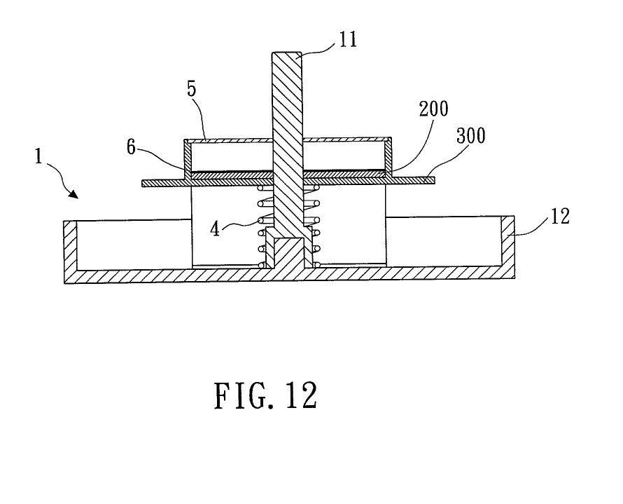

FIGS. 11 and 12 illustrate the seventh embodiment of the invention. In this case, the first “Π” type of accepting base 200 and the second “Π” type of accepting base 300, and the resilient support module 4 are applied to other devices. The figure shows part of the structure for the product, including a base 1 and a central pillar 11, wherein, base 1 and central pillar 11 can be a one-body structure, or they can be separate modules and combined together. As the case of one-body, normally, the bottom base of CD-R storage box is a typical example; as the case of separating modules, base cover of CD cleaning box with a separate extended central pillar. The operating method of the mechanism of the embodiment is completely same as the embodiment of FIG. 5.

In the embodiment, the first “Π” type of accepting base 200 as sticker accepting base can be changed to the “U” type of sticker accepting base 2 in FIG. 3 of the embodiment, or the “Π” type of sticker accepting base 2 in FIG. 4 of the embodiment. The operating methods are the same as that of the embodiments of FIGS. 3 and 4 respectively. The sticker accepting base of such structures will not beyond the range of the invention.

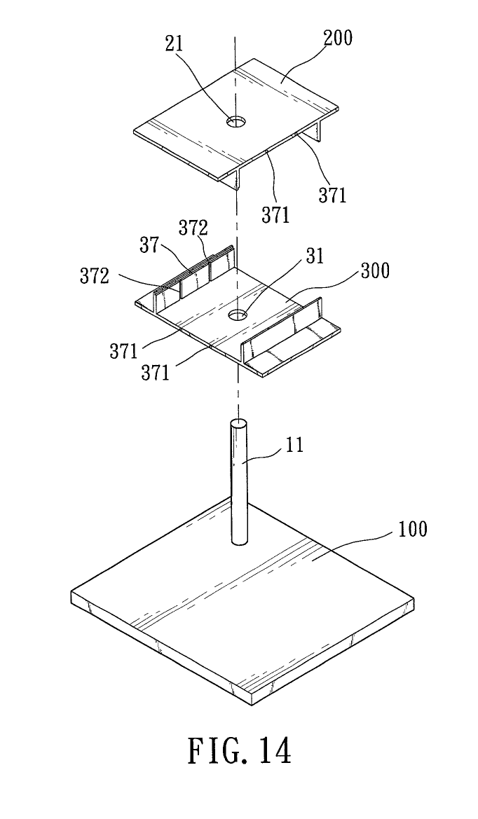

FIG. 14 is the ninth embodiment of the invention. The embodiment includes two “Π” types of modules and a central pillar. They are the first “Π” type of accepting base 200, the second “Π” type of accepting base 300, and the central pillar 11 which formed on a base 100. Both of the first “Π” type of accepting base 200 and the second “Π” type of accepting base 300 are with the functions of sticker accepting base and CD accepting base, and they all have the vertical side plates and sticker accepting planes. When one of the accepting bases plays the role of sticker accepting base, another can be CD accepting base, and vise versa. The every one of the internals of the two side plates for each “Π” type of accepting base has at least one guiding slot 372. Each of the vertical side surfaces of the two parallel straight edges for accepting plane is with at least one convex point 371, which is cooperated with guiding slot 372. When operating, each convex point 371 is mated with cooperative guiding slot 372, and the convex is against to the internal of the guiding slot, thus, the friction between them can be a buffer in operation. The above buffer function is the same as that of the previously mentioned resilient support module 4.

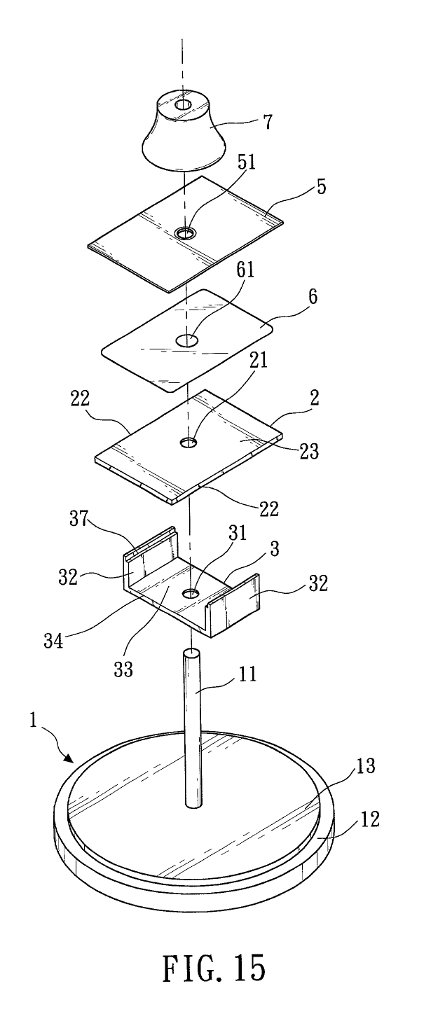

FIG. 15 is the tenth embodiment of the invention. The structure includes a base 1, sticker accepting base 2, CD accepting base 3 and locking upper disc 7. The base 1 is furnished with a central pillar 11. The CD accepting base 3 is fixedly mounted on somewhere of the central pillar 11. Basic structure of this embodiment is very similar to the mechanism of FIG. 1. The difference is in the operating principle. When operating, firstly, sticker 6 (not shown in figure) is placed on the accepting plane 23 of sticker accepting base 2. Secondly, placing CD 5 on ladder plane 37 of the two top side plates 32 of CD accepting base 3. The locking upper disc is put on CD and the function for locking up disc 7 is to keep CD on the same position for not moving and rotating. In operation, pressing on the locking upper disc 7 by hand firstly, and pulling up the sticker accepting base 2 with sticker 6 secondly. Let glued surface of sticker touch onto sticking surface of CD to finish the work for labeling sticker.

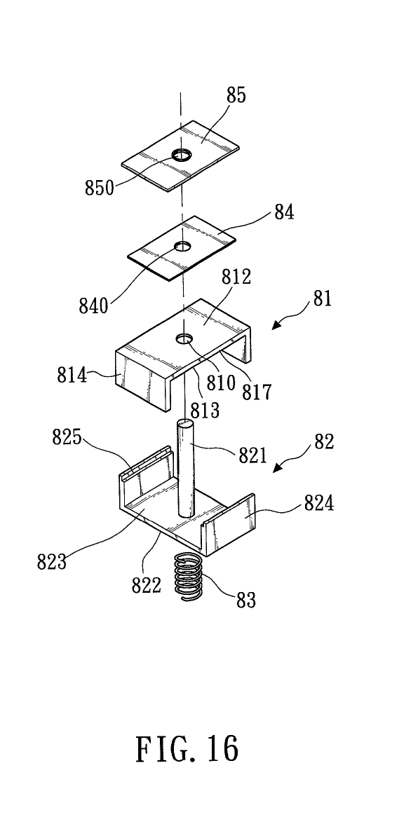

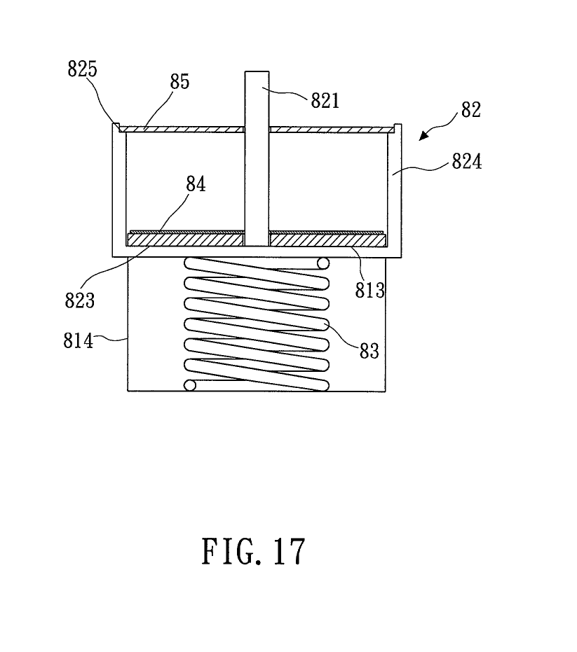

Please refer to FIGS. 16 and 17; this is the eleventh embodiment of the invention, including a sticker accepting base 81 (first accepting base), a CD accepting base 82 (second accepting base) and a resilient support module 83.

The sticker accepting base 81 is a module having at least two parallel straight edges 817 and the shape of placing “U” upside down. There are two vertically extended foot bases 814 (also referred as first side plate) which are toward down installed on the two sides of the sticker accepting base 81, and the base can then stand up. A sticker accepting plane 812 (also called as first accepting plane) is located on the sticker accepting base 81 at a back side opposite to the foot bases 814. The sticker accepting plane 812 is formed with a central hole 810. Another side surface of the accepting plane 812 is the bottom plane 813 (first bottom plane, positioned between the two foot bases 814). Distance between the two parallel straight edges 817 of the sticker accepting plane 812 (or the width of the sticker accepting plane 812) is equal to the distance between the two vertical side plates 824 (second side plate) of the CD accepting base 82. And such distance is enough to load labeling sticker 84 (or first plane module). Sticker accepting base 81 is to load labeling sticker 84 and can be a guidance for CD accepting base 82 moving up and down. The accepting plane 812 of the sticker accepting base 81 keeps a suitable distance with CD 85 (or second plane module) over the said accepting plane 812.

Another preferred embodiment, the said foot bases 814 are not formed by the plate type of structure as shown in FIG. 16. It can also be a table-leg structure installed on the four corners of sticker accepting base 81, or any other foot base structure which supports sticker accepting base 81.

CD accepting base 82 is as a “U” type of module, and has a bottom plane 823 (second bottom plane) that is installed a positioning central pillar 821 on the center of bottom plane. The positioning central pillar 821 is to keep concentric of the sticker accepting base 81, CD accepting base 82, labeling sticker 84 and CD 85. It is also the guidance for CD accepting base 82 moving up and down. The bottom plane 823 is formed with two vertical side plates 824 (second side plate) which are parallel to each other. There are two ladder planes 825 on top of the parallel side plates 824 for supporting the business card type of CD 85. The two parallel side plates 824 and the ladder planes 825 restrict the two parallel straight edges of CD 85, and then CD 85 cannot then be rotated. The parallel side plates 824 frame sticker accepting base 81 and labeling sticker 84 to prevent rotation. Therefore, the relative angular position and central line for CD 85 and sticker 84 are always constant. That is the partnership of the central pillar 821, the two parallel side plates 824 (second side plates) and the two parallel straight edges 817 consists a precise positioning and guiding mechanism (including central positioning and moving guidance). Hence, the relative angular position and central line between CD 85 and sticker 84 are constant while sticking.

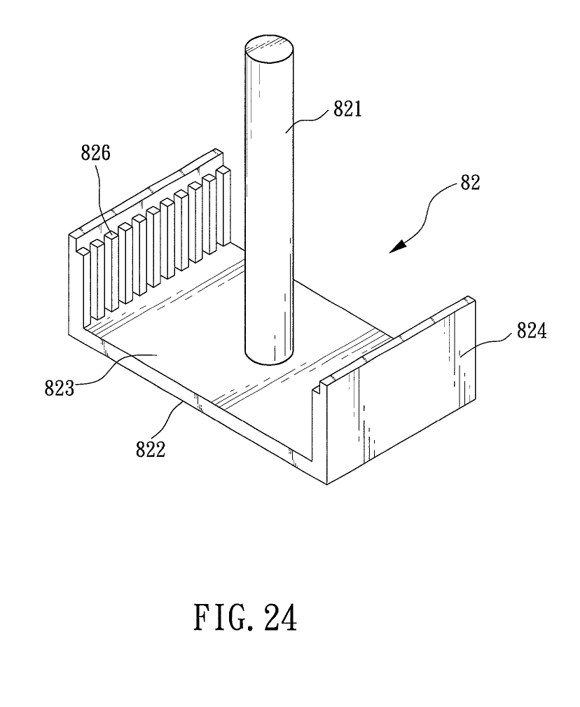

The ladder planes 825 of the two top side plates 824 of CD accepting base 82 support the two parallel straight edges of CD 85. There are plural steps on ladder planes 825 for different widths of business card types of CDs 85. The ladder planes 825 can be replaced by other mechanism with same function, for example, the vertical ribs 826 on the internal of the two side plates (referring to FIG. 24). Of course, the method to support CD 85 is not limited to the above mentioned and any other extended application form will not beyond the range of the invention. For instance, the second side plates 824 are not necessary to be plate shape of structure, or table-leg, grid structure, etc. That is, any structure that can support CD 85 on its top still belongs to the application range of the invention.

Resilient support module 83 is for supporting CD accepting base 82, and it can be a single module or directly fixed on the bottom side of CD accepting base 82. Before operating, the resilient support module 83 is under the condition of uncompressed. The resilient support module 83 supports CD accepting base 82, thus, the ladder planes 825 of the two top side plates 824 of the CD accepting base 82 keeps a suitable distance with the sticker accepting plane 812 and the sticker 84. CD accepting base 82 is at the first position (as shown in FIG. 17) at this moment.

CD 85 and CD accepting base 82 go down together when in operating. The resilient support module 83 is being compressed until CD 85 touches onto sticker 84 on sticker accepting plane 812, the sticker 84 is then precisely stuck on CD 85. CD accepting base 82 is at the second position at this moment.

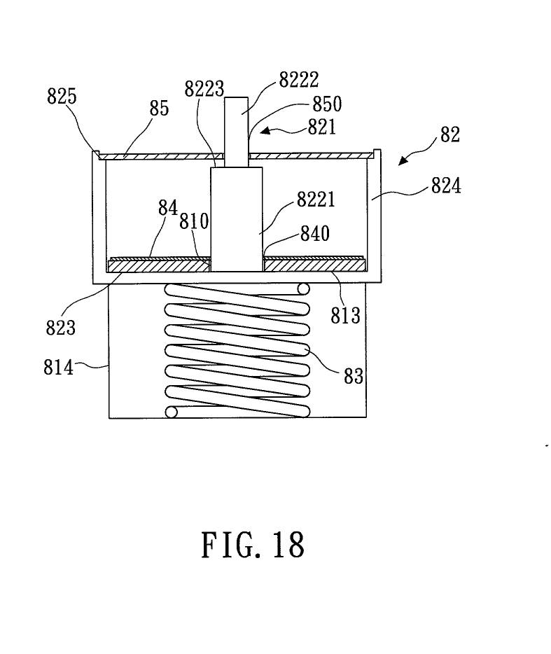

As shown in FIG. 18, which is the twelfth embodiment. Central pillar 821 of CD accepting base 82 consists of two different diameters of cylinder 8221 and 8222. The lower section close to bottom plane 823 of central pillar 821 is big cylinder 8221 (first cylinder), and small cylinder 8222 (second cylinder) protrudes from top plane 8223 of big cylinder 8221, both are concentric. Central hole 810 of sticker accepting plane 812 has a diameter equal to the diameters of sticker central hole 840 and big cylinder 8221. Diameter for central hole 850 of CD 85 is same with the diameter of small cylinder 8222. Top plane 8223 of big cylinder 8221 is not higher than top ladder planes 825 of two side plates 824. Ladder planes 825 support CD 85.

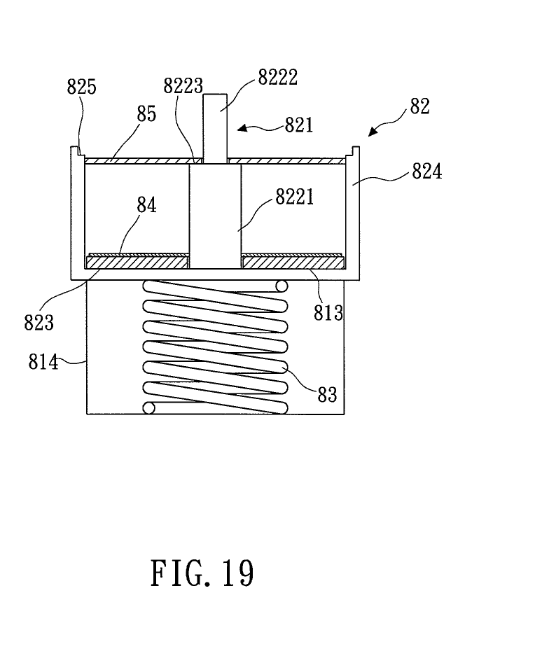

Referring to FIG. 19, which is the thirteenth embodiment of the invention. The embodiment which structure is same with the embodiment of FIG. 18. Top plane 8223 of central pillar 821 is lower than ladder planes 825, and CD 85 is supported by top plane 8223 of big cylinder 8221 and its two parallel straight edges are framed by two side plates 824. The width of CD 85 is the same as the internal width formed by the two side plates 824. So CD 85 cannot rotate randomly and can only move with CD accepting base 82 up and down. Hence, the embodiment can be applied to that the width of CD 85 is smaller. As the mention above, FIG. 19 (or FIG. 18) shows same structure of the embodiment, however the labeling device for the invention can be suitable for more different dimensions of business card CD 85.

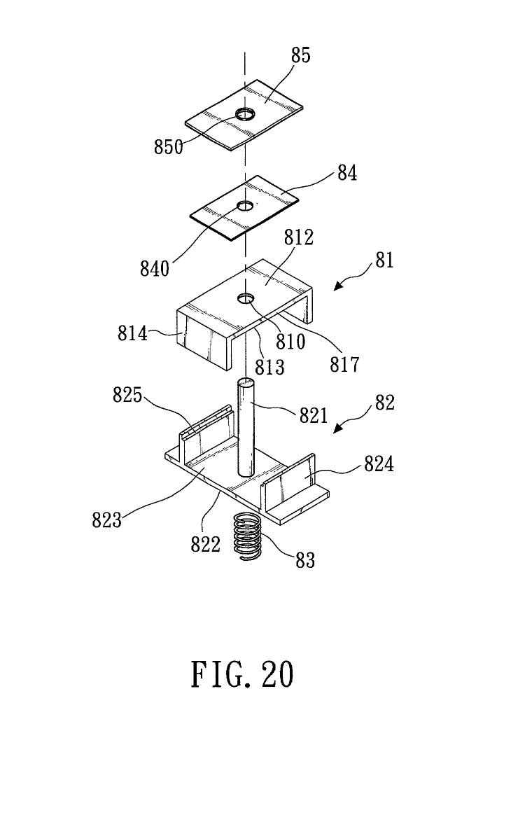

Referring to FIG. 20, which is the fourteen embodiment of the invention. In the embodiment, CD accepting base 82 is a “Π” type of module. Another words, the out side of the two parallel second side plates 824 form wing type (or fin type) of protruding structure (not numbered) for users' convenience to push CD accepting base 82 down.

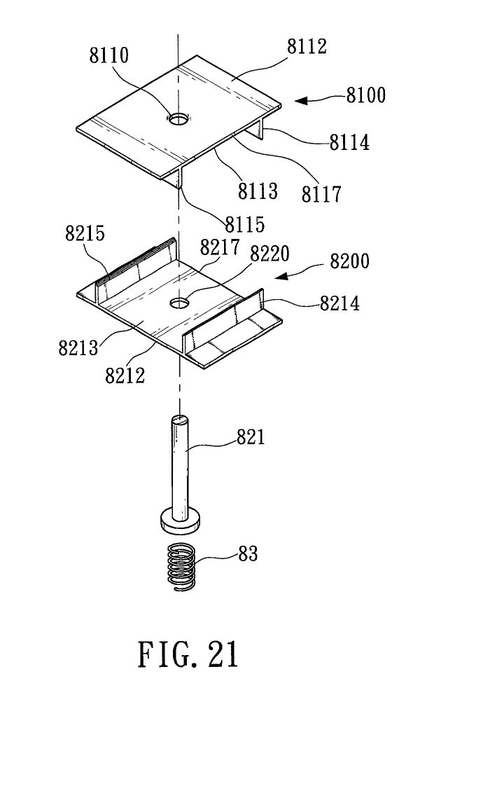

As showing in FIG. 21, which is the fifteenth embodiment of the invention. Wherein, both of CD accepting base and sticker accepting base are “Π” type of modules (both are with wing type of protruding structures on the out side of side plates 8114 and 8214), and they are individually called first accepting base 8100 (sticker accepting base) and second accepting base 8200 (CD accepting base). The shapes for them are same, but the dimensions are different. Central pillar 821 is the module which can be taken apart. Central pillar 821 combines with any one of these “Π” types of modules to be as CD accepting base; another module which does not combine with central pillar can be as sticker accepting base. The roles for the “Π” type of two modules can be exchanged, and moreover, the applications are suitable for different dimensions of business card CDs from designing different dimensions of the two modules. First accepting base 8100 has a first accepting plane 8112 (sticker accepting plane), and there is a central hole 8110 on the center of accepting plane 8112. The other side of first accepting plane 8112 is another plane called first bottom plane 8113. The said first bottom plane 8113 is with two parallel straight edges (means first parallel straight edges 8117) and two parallel first side plates 8114 vertical to first bottom plane 8113. The ends of the said first side plates 8114 have first ladder planes 8115. With same logically design, second accepting base 8200 also has second accepting plane 8212 (placed on the other side of second accepting base 8200 and second side plate 8214), second bottom plane 8213, second parallel straight edges 8217, second side plates 8214 and second ladder planes 8215.

For the embodiment, the width of first accepting plane 8112 (means the distance between the two parallel straight edges 8118) is equal to the distance between the two second side plates 8214. Same as the above mention, the width of second accepting plane 8212 is also equal to the distance between the two first side plates 8114. The two widths of first accepting plane 8112 and second accepting plane 8212 are not necessary to be equal. The invention is applied to more different widths of business card CDs if the above widths are distinct.

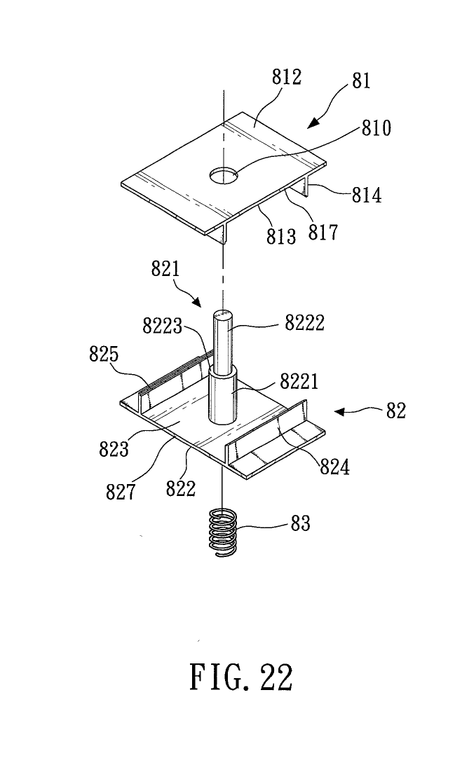

As showing in FIG. 22, which is the sixteenth embodiment of the invention. The structure is same as the embodiment of FIG. 6, and the only difference is that consisting central pillar 821 via two dissimilar diameters of cylinder 8221 and 8222, but concentric. Another point is that central pillar 821 can be a single module or integrally formed on second accepting base 82. The top plane 8223 of big cylinder 8221 is not higher than the two top ladder planes 825 of the two side plates. The ladder planes 825 of the end side plates support CD. In case of smaller width of CD, using top plane 8223 of big cylinder to support CD is another choice.

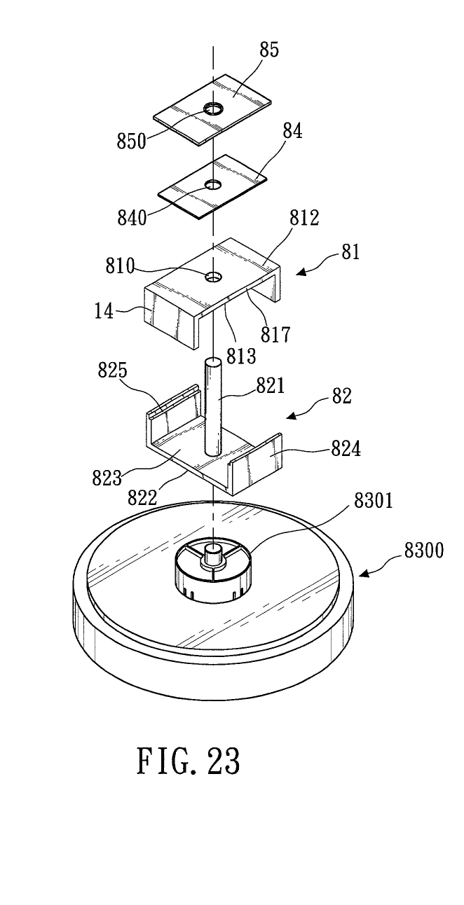

Referring to FIG. 23, which is the seventeenth embodiment of the invention. The embodiment replaces the resilient support module with a CD labeling machine 8300. Generally, CD labeling machine 8300 has a moving and positioning base 8301, which is with functions of support and stretch and shrink.

As showing in FIG. 24, which is the eighteenth embodiment of the invention. The ladder planes 825 of the two top parallel side plates 824 are replaced by vertical ribs 826 of bottom plane 823. The top planes of ribs 826 are to support CD 85.

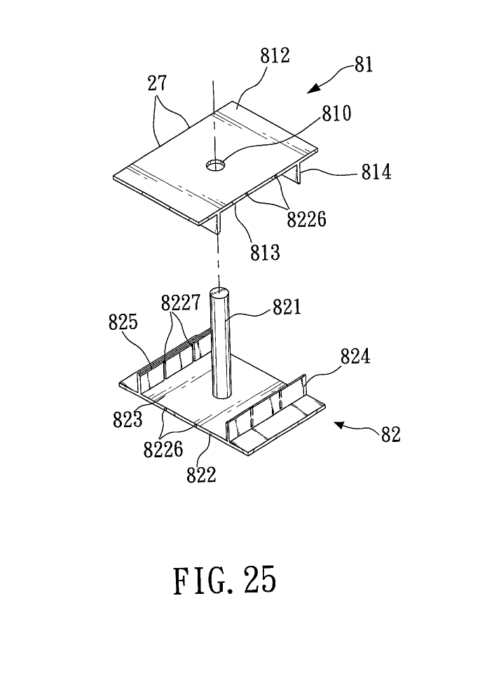

The embodiment in FIG. 25 is the nineteenth embodiment of the invention. In this case, between sticker accepting base 81 and CD accepting base 82 has convex points 8226 and slots 8227 structures for friction. Then, CD accepting base 82 is fixed on certain position before pushed and pulled. Wherein, convex points 8226 are placed on the parallel straight edges of sticker accepting base 81. The internal surfaces of the two parallel side plates 824 for another module where the relative positions are with slots 8227, and the two structures are joined each other. The two “Π” type of accepting base 81 and 82 are both with slots 8227 and convex points 8226. On the other hand, convex points 8226 and slots 8227 which positions can be exchanged.

As the above mentioned, the labeling device of business card type of CD for the invention can effectively label labeling sticker onto business card CD. Furthermore, the invention is able to combine with other products to offer same function for increasing value.

While the present invention has been particularly shown and described with reference to some preferred embodiments, it will be understood by those skilled in the art that various changes in form and detail may be without departing from the spirit and scope of the present invention.

I claim:

1. A labeling device, which applies a first plane module with at least two parallel straight edges onto a second plane module with at least two parallel straight edges, each of the said first plane module and the said second plane module has a central hole, and the labeling device comprising:
a first accepting base, which is with a first accepting plane for supporting the first plane module, and the first accepting plane has at least two parallel straight edges where are relative to the two parallel straight edges of the first plane module;
a second accepting base, which is with a second bottom plane, and the second bottom plane has at least two parallel and extended second side plates which stand up on the second bottom plane, furthermore, the distance between the two second side plates is about equal to the distance between the two parallel straight edges of the second plane module, the two parallel straight edges of the second plane module can be supported by end planes of the second side plates, and the position of the two second side plates are adjacent to the two parallel straight edges of the first plane module, the first accepting base can be located between the two second side plates having the first accepting plane facing toward the ends of the two second side plates;
a positioning mechanism, which includes the mechanism of central positioning and moving positioning, and it keeps both central holes of the first plane module and the second plane module on the same axial line; when the first accepting base and the second accepting base moving relatively between a first position and a second position, there is no relative rotation between the first plane module and the second plane module.

2. The device as recited in claim 1, wherein, the positioning mechanism comprises a central pillar and a boundary formed by the two second side plates; the central pillar penetrates through central holes of said two modules and the central hole of the first accepting base; the boundary formed by the two second side plates keeps the relative angular position between the first plane module and the second plane module fixed, and so there is no relative rotation between them.

3. The device as recited in claim 2, wherein, an end of the central pillar of the positioning mechanism connects with a moving and positioning base, the moving and positioning base is sitting on a base and is capable of moving up and down.

4. The device as recited in claim 2, wherein, the central hole of the first plane module is larger than the central hole of the second plane module, and the central pillar is formed with different diameters of upper and lower sections, which are a first diameter of upper section and a second diameter of lower section, furthermore, top plane of the second diameter of the central pillar is lower than top ends of the two second side plates, and the first diameter is the same as the diameter of the central hole of the second plane module, also, the second diameter is the same as the diameter of the central holes for the first plane module and the first accepting base.

5. The device as recited in claim 4, wherein, an end of the central pillar of the positioning mechanism combines with a moving and positioning base, the moving and positioning base is sitting on a base and is capable of moving up and down.

6. The device as recited in claim 2, wherein, top ends of the two second side plates are formed with planes for supporting two parallel straight edges of the second plane module; said planes is one of the following: ladder planes of the ends of the side plates, and top end planes of ribs vertical to the internal of the side plates.

7. The device as recited in claim 2, wherein, the second accepting base is supported by a support mechanism, said support mechanism is one of the following: a resilient mechanism with stretching and shrinking abilities, and a mechanism with frictional convex points and guiding slots;
when there is no force applied to the second accepting base, the support mechanism keeps the second accepting base to the first position, on the other hand, the second accepting base moves to the second position after a force being applied to it.

8. The device as recited in claim 1, wherein, the first accepting base can be shaped as one of the following: plane, U and Π type; the second accepting base structure can be shaped as one of the following: U and Π type; the first accepting plane of the first accepting base is positioned between the two second side plates of the second accepting base, furthermore, the two distances for the two parallel straight edges of the first accepting plane and the two second side plates are equal.

9. The device as recited in claim 1, wherein, both the first accepting base and the second accepting base are shaped as one of the following: U and Π type; the two first side plates of the first accepting base and the two second side plates of the second accepting base are engaged in right angle, the distance between the two first side plates of the first accepting base is equal to the distance between the two second side plates of the second accepting base; the two second side plates' distance is same as the distance of the two parallel straight edges of the first accepting plane.

10. A labeling device, which applies a first plane module with at least two parallel straight edges onto a second plane module with at least two parallel straight edges, each of the first plane module and the said second plane module has a central hole, and the labeling device including:
a first accepting base, which is with a first accepting plane for supporting the first plane module, and the first accepting plane has at least two parallel straight edges where are relative to the two parallel straight edges of the first plane module, furthermore, the distance between the two parallel straight edges is equal to the width of the first plane module, and there is a center hole in the center of the first accepting plane;
a second accepting base, which is with a second bottom plane, and the said second bottom plane has two parallel second side plates vertical to the second bottom plane, furthermore, the distance between the two second side plates is about equal to the distance for the two parallel straight edges of the second plane module, thus, the two parallel straight edges of the second plane module can be supported by top ends of the two second side plates, and the positions for the two second side plates are relative to the two parallel straight edges of the first accepting plane, also, the distance between the two second side plates is equal to the width of the first accepting plane, hence, the first accepting base can be placed between the two side plates, and the first accepting plane is toward to top ends of the two second side plates;
a positioning and guiding mechanism, which is the mechanism for central positioning and guiding, and keeps the first accepting base, the second accepting base, the first plane module and the second plane module on a same axial line; when the first accepting base and the second accepting base moving relatively in between a first position and a second position, there is no relative rotation between the first plane module and the second plane module; meanwhile, when the second accepting base is at the first position, the first plane module and the second plane module are separated, moreover, when the second accepting base is at the second position, the first plane module touches the second plane module.

11. The device as recited in claim 10, wherein, the positioning and guiding mechanism comprises a central pillar in the center of the second bottom plane of the second accepting base, two parallel second side plates extending vertically out of the second bottom plane.

12. The device as recited in claim 11, wherein, the central pillar consists of two concentric cylinders of different diameters, and the diameters are larger diameter of first cylinder and smaller diameter of second cylinder; top plane of the first cylinder is not higher than end planes of the two top second side plates of the second accepting base, and the diameters of the central holes of the first accepting base and the first plane module are equal to the first cylinder's diameter, furthermore, the second cylinder's diameter is the same as that of the central hole of the second plane module.

13. The device as recited in claim 12, wherein, the top plane of the first cylinder is lower than the ladder planes of the two top second side plates, and the top plane of the first cylinder is for loading the second plane module.

14. The device as recited in claim 10, wherein, the top ends of the second side plates are with ladder plane structures, and the two parallel straight edges of the second plane module are supported by the ladder planes and also restricted by side plates and ladder planes, hence, the second plane module can not turn free, furthermore, the width of the first plane module is a little bit smaller than that of the second plane module.

15. The device as recited in claim 10, wherein, internal surfaces of the two second side plates which face to each other are formed with a plurality of ribs which are extended vertically from the second bottom plane and same length with each other, as well as tops of the ribs are lower than the tops of the two second side plates, therefore, the top ends of the two second side plates formed as ladder plane structures are to support the two parallel straight edges of the second plane module, and the width of the first plane module is a little bit smaller than that of the second plane module.

16. The device as recited in claim 10, wherein, the structure of the first accepting base can be one of the following: plane, U and Π type; the second accepting base structure can be one of the following: U and Π type.

17. The device as recited in claim 10, wherein, the structures of both the first accepting base and the second accepting base can be one of the following: U and Π type.

18. The device as recited in claim 17, wherein, the distance between the two first side plates of the first accepting base is not equal to the distance between the two second side plates of the second accepting base.

19. The device as recited in claim 10, wherein, the second accepting base is supported by a support mechanism, the support mechanism can be one of the following: a resilient mechanism with stretching and shrinking abilities, a movable mechanism with stretching and shrinking abilities, a mechanism with frictional convex points and guiding slots.

20. A labeling method, which applies a first plane module with at least two parallel straight edges onto a second plane module with at least two parallel straight edges, each of the first plane module and the said second plane module has a central hole, and the labeling method comprises:
putting a first accepting base onto a second accepting base with two second side plates which vertically standing on the said second accepting base and parallel to each other, thus, the two second side plates frame the first accepting base to avoid relative turning between them, and linear and relative movement between the first accepting base and the second accepting base can be performed along the vertical extending direction of the second side plates;
placing a first plane module on the first accepting base and the first plane module rests in the plane which faces to ends of the second side plates;
supporting the second plane module between the second side plates and keeping a suitable distance with the first plane module via a mechanism;
keeping the centers of the first plane module and the second plane module on a same axial line via a central positioning mechanism;
making that the first accepting base faces to the ends of the second side plates and proceeding the relative linear movement mentioned above until the first plane module contact the second plane module.

21. The method as recited in claim 20, wherein, the central positioning mechanism comprises a central pillar, which penetrates through the centers of the first accepting base, the first plane module and the second plane module, and there is at least one of the accepting bases between the first accepting base and the second accepting base, capable for proceeding linear and relative movement along the ce central pillar.

22. The method as recited in claim 21, wherein, the mechanism for supporting the second plane module between the second side plates comprises a central pillar, which includes two different diameters of cylinders, and the diameters are larger diameter of a first cylinder and smaller diameter of a second cylinder; top plane of the first cylinder is not higher than ends of the two second side plates, and the central holes for the first accepting base and the first plane module comparing with the first cylinder's diameter are equal, furthermore, the second cylinder's diameter is same as the central hole of the second plane module, which means that central hole of the first plane module is larger than central hole of the second plane module, therefore, the top plane of the first cylinder can be used for supporting the second plane module which is resting between the two second side plates.

23. The method as recited in claim 20, wherein, the mechanism for supporting the second plane module between the second side plates is ladder planes mechanism set on ends of the second side plates, and two parallel straight edges of the second plane module are supported by the ladder planes, thus, the two parallel straight edges are also limited by the second side plates and ladder planes and cannot turn free; furthermore, the width of the first plane module is a little smaller than the width of the second plane module.

24. A labeling device for applying a first plane module with at least two parallel straight edges onto a second plane module with at least two parallel straight edges, each of the first plane module and the said second plane module has a central hole, said labeling device comprising:
an accepting plane for supporting one of the plane modules thereon;
at least two side plates vertically extending from the accepting plane, said side plates being parallel to and spaced from each other at a distance which is equal to the distance between the two parallel straight edges of the second plane module; and
a pillar having a diameter equal to which of the second plane module, said pillar being capable to pass through the central holes of both plane modules.
